(19) United States
(12) Patent Application Publication
(10) Pub. No.: US 2019/0178210 A1
(43) Pub. Date: Jun. 13, 2019

(54) WORK APPARATUS WITH A GAS-OPERATED COMBUSTION ENGINE

(71) Applicant: Andreas Stihl AG & Co. KG, Waiblingen (DE)

(72) Inventors: Manuel Dangelmaier, Wernau (DE); Malte Hartmann, Hong Kong (CN); Thomas Schiele, Winterbach (DE)

(21) Appl. No.: 16/215,310

(22) Filed: Dec. 10, 2018

(30) Foreign Application Priority Data
Dec. 8, 2017 (DE) 10 2017 011 345.9

(51) Int. Cl. F02M 37/00; F02M 37/02; F02M 17/04; F02B 63/02; F02M 31/14; F01N 5/02

(52) U.S. Cl. CPC F02M 37/0017; F02M 37/02; F02M 37/007; F01N 5/02; F02M 17/04; F02B 63/02; F02M 31/14; F02M 37/0076

(57) ABSTRACT

A handheld work apparatus includes a gas-operated combustion engine which has a cylinder with a combustion chamber, the combustion chamber being delimited by a piston. The combustion engine is fed combustion air via an intake channel and liquid gas via a supply line. The liquid gas enters into an opening of the supply line in a gas tank, it being possible for the position of the opening of the supply line in the gas tank to be adjusted. A longitudinal section of the supply line lies within the gas tank and is formed from a flexible hose. A weight is arranged in the region of the opening in such a way that liquid gas is fed via the opening to the supply line of the mixture formation unit in every operating position of the work apparatus.

### CROSS REFERENCE TO RELATED APPLICATION

This application claims priority of German patent application no. 10 2017 011 345.9, filed Dec. 8, 2017, the entire content of which is incorporated herein by reference.

### FIELD OF THE INVENTION

The invention relates to a work apparatus with a gas-operated combustion engine which has a cylinder with a combustion chamber which is delimited by a piston. The combustion engine has an intake channel for feeding in combustion air and an exhaust gas outlet for discharging combustion gases. A flammable gas is fed to a mixture formation unit via a supply line. The gas enters into an opening of the supply line within a gas tank of the work apparatus, it being possible for the position of the opening of the supply line in the gas tank to be adjusted.

### BACKGROUND OF THE INVENTION

A handheld work apparatus of this type is known from U.S. Pat. No. 8,807,240 B2. The gas tank is an exchangeable gas cartridge which is inserted upside down into a receptacle on the housing of the work apparatus. In a manner which is dependent on the operating position of the work apparatus which is configured as a brushcutter, the user has to adjust an extraction stub which lies in the liquid gas and adapt it to the operating position of the work apparatus, in such a way that an undisruptive extraction of liquid gas is ensured. If the user changes the operating position of the work apparatus without adjusting the extraction stub in the gas cartridge, the extraction stub can protrude out of the liquid gas, with the result that only gaseous gas is extracted, which can lead to operating disruptions of the combustion engine.

### SUMMARY OF THE INVENTION

It is an object of the invention to configure a handheld work apparatus with a gas-operated combustion engine and a gas tank in such a way that the feed of liquid gas is ensured in every operating position of the work apparatus without an intervention of the user.

The object can, for example, be achieved via a handheld work apparatus including: a gas-operated combustion engine having a cylinder with a combustion chamber; the combustion engine including a piston and an intake channel for feeding in combustion air; a supply line for a flammable gas; the combustion chamber being delimited by the piston; the combustion engine including a mixture formation unit; a gas tank; the supply line having an opening defining a position in the gas tank; the supply line being configured to feed liquid gas to the mixture formation unit, the liquid gas entering into the opening of the supply line within the gas tank, wherein the position of the opening in the gas tank is adjustable; the supply line including a longitudinal section disposed within the gas tank; and, the longitudinal section including a flexible hose and a weight arranged in a region of the opening in such a manner that the liquid gas is fed via the opening to the supply line.

In order to ensure that liquid gas is extracted from the gas tank in every operating position of the work apparatus, a longitudinal section of the supply line, which longitudinal section lies within the gas tank, is configured as a flexible hose. A weight is arranged, in particular a weight body is attached, in the region of the opening of the flexible hose, as a result of which a weight force always acts on the free end of the flexible hose independently of the operating position of the work apparatus. This ensures that the opening of the hose of the supply line lies in each case in the liquid gas independently of the operating position of the work apparatus, with the result that liquid gas is fed to the mixture formation unit in every operating position of the work apparatus. Disruption-free operation of the handheld work apparatus is ensured independently of its operating position.

The opening of the supply line is advantageously configured as a suction housing, the weight being arranged in the suction housing.

In order to ensure a high movability of that longitudinal section of the supply line which lies within the gas tank, it is provided that the elastic hose is provided from the opening of the supply line as far as a pass through of the supply line through the tank wall.

The gas tank is configured, in particular, as a refillable gas tank which is attached fixedly on the combustion engine or the work apparatus as an operating medium tank which is fixed on the apparatus. The gas tank can thus be connected to the crank case of the combustion engine in a mechanically fixed manner, expediently via holding elements which are configured on the crank case.

The gas tank has a fill valve for liquid gas, a pressure relief valve for gaseous gas and an extraction valve for liquid gas. In one particular development, a level gage which indicates a predefined filling level of the gas tank is arranged in the gas tank. The level gage is expediently configured as a float which closes at least the fill valve when a predefined filling level is reached. It can also be expedient to close the pressure relief valve via the float. In one particular development, both the fill valve and the pressure relief valve can be controlled by a common float.

In an embodiment, the level gage lies within a protective cage which is provided within the gas tank. The flexible hose of the supply line, which flexible hose is arranged in the gas tank, lies outside the protective cage, with the result that a mechanical impediment of the level gage by way of the hose which moves in the gas tank in a manner which is dependent on changing operating positions is prevented.

The liquid gas which is extracted from the gas tank is fed to an evaporator which is heated, in particular, by the waste heat of the combustion engine. The thermal energy which is necessary for evaporating can thus be provided in a simple way.

The evaporator advantageously lies in the spatial region of the cylinder of the combustion engine and/or in a spatial region of the exhaust muffler of the combustion engine. Sufficient waste heat which can be sufficient for heating the evaporator arises in the spatial regions.

A pressure reliever is connected downstream of the evaporator, the outlet of which pressure reliever opens into the control chamber of a membrane carburetor. It can be expedient that the gaseous gas which is to be fed to the membrane carburetor is raised toward the temperature of the combustion air which is fed in, before the introduction into the mixture formation unit. This is achieved simply by virtue of the fact that the gaseous gas is guided through a heat exchanger, around which the inflowing combustion air flows.

Further advantageous embodiments result from any desired combination of the features of the mentioned and described embodiments.

### BRIEF DESCRIPTION OF THE DRAWINGS

The invention will now be described with reference to the drawings wherein:

FIG. 1 shows a diagrammatic side view of a handheld work apparatus using the example of a motorized chainsaw;

FIG. 2 shows a diagrammatic side view of a handheld work apparatus using the example of a blower;

FIG. 3 shows a diagrammatic illustration of a combustion engine with a flange-connected gas tank as an operating medium tank;

FIG. 4 shows a diagrammatic partially sectioned view of the gas tank as an operating medium tank on a combustion engine in accordance with FIG. 3;

FIG. 5 shows a schematic illustration for feeding liquid gas to a mixture formation unit of a combustion engine; and,

FIG. 6 shows a schematic illustration in accordance with FIG. 5 with a heat exchanger which is provided in the air inflow of the combustion engine.

### DESCRIPTION OF THE PREFERRED EMBODIMENTS OF THE INVENTION

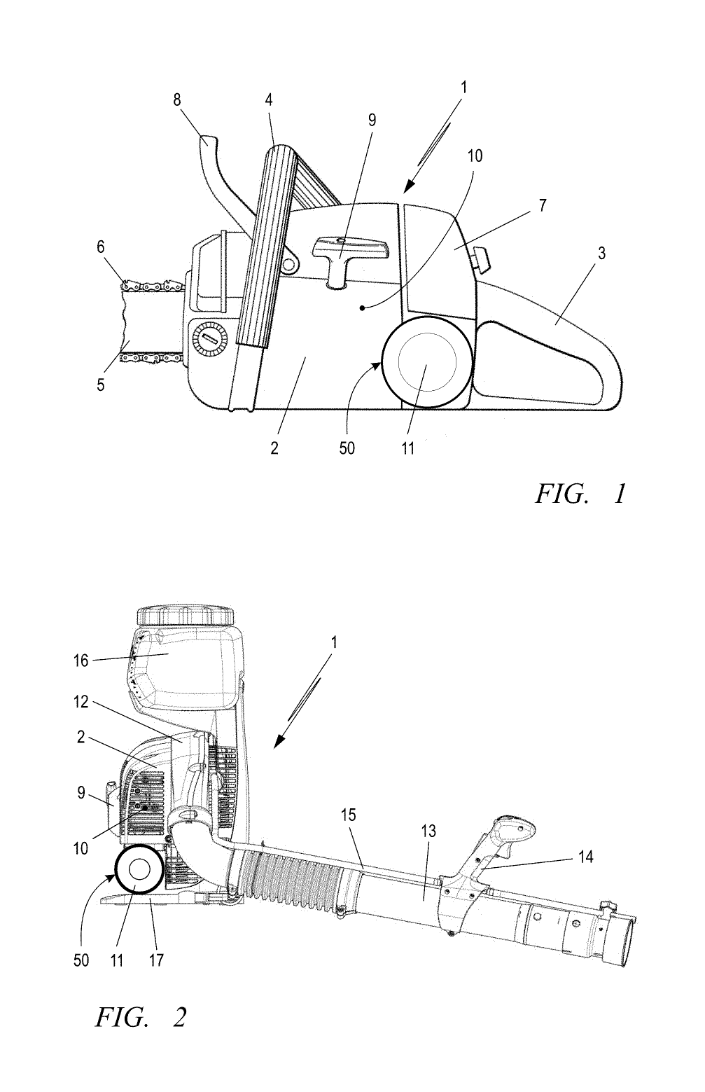

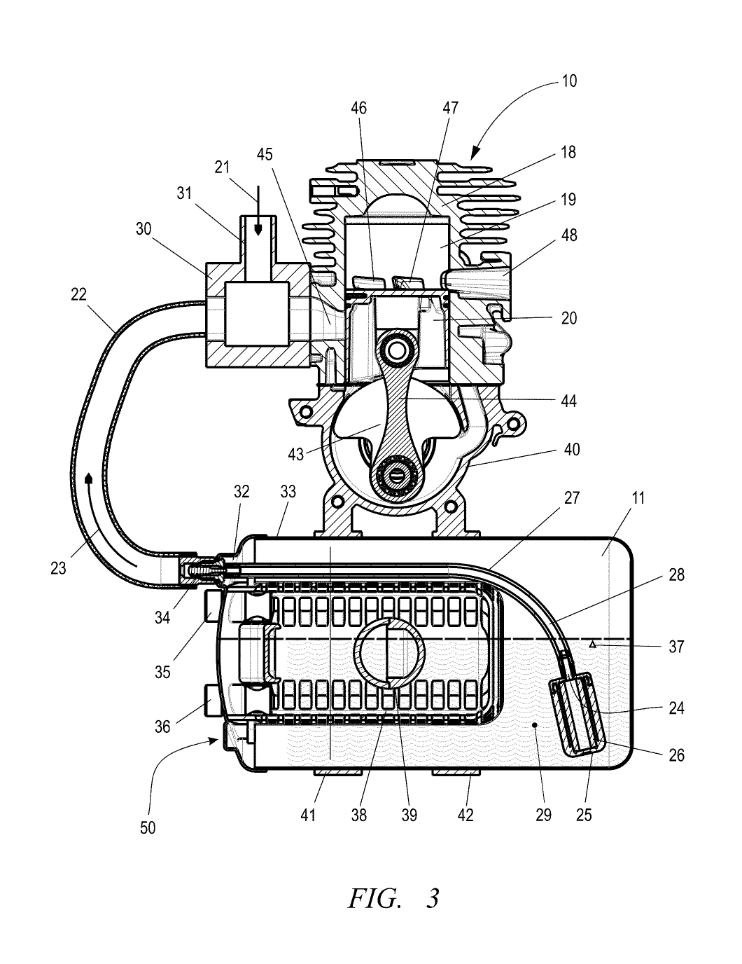

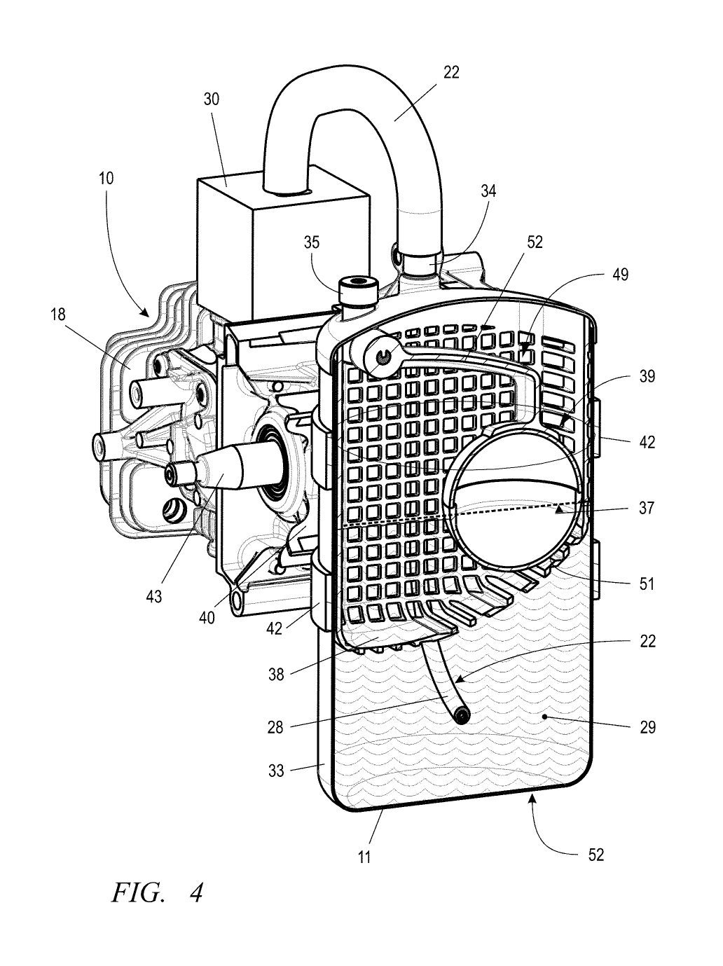

FIG. 1 shows a handheld work apparatus 1 using the example of a motorized chainsaw. The work apparatus 1 has a housing 2 which has a rear handle 3 and an upper bale handle 4. The handle 3 extends in the longitudinal direction of the work apparatus 1; a guide bar 5 which is provided at the front end of the housing 2 also extends in the longitudinal direction. A saw chain 6 circulates on the guide bar 5, which saw chain 6 is driven via a chain sprocket (not shown) by a combustion engine 10 which is provided in the housing 2. The combustion engine 10 which is shown physically in FIGS. 3 and 4 is operated using liquid gas from a gas tank 11 which is provided as an operating medium tank 50. In the embodiment in accordance with FIG. 1, the gas tank 11, as operating medium tank 50, lies in the housing 2 of the work apparatus 1 below an air filter 7 in the region of the rear handle 3.

The operation of the saw chain is monitored by way of a safety brake device; a hand protective bracket 8 as an actuating element of the safety brake device in front of the front, upper bale handle 4.

In the embodiment which is shown, the combustion engine 10 is started by way of a pull-rope starter 9. A spring starter, an electric starter or a starting device of this type can also be provided as starting device.

FIG. 2 shows a work apparatus 1 in the form of a blower, in the housing 2 of which a combustion engine 10 is arranged. The combustion engine 10 drives a fan impeller which is arranged in a blower housing 12. The blower housing 12 opens into a blower tube 13 which can be operated via a handle 14.

A spray fluid which is stored in a spray fluid tank 16 is fed to the blown air flow via a line 15.

A gas tank 11 as operating medium tank 50 lies below the combustion engine 10 between the carrier frame 17 of the back-pack blower and the housing 2 of the drive. Liquid gas is fed as operating medium from the gas tank 11 to the combustion engine 10.

FIGS. 3 and 4 show in detail how the gas tank 11 is connected to the combustion engine 10 and in what way gas is fed in a liquid phase from the gas tank 11 to a mixture formation unit 30 of the combustion engine 10.

The gas-operated combustion engine 10 has a cylinder 18 with a combustion chamber 19 which is delimited by a piston 20. An intake channel 31 is configured, expediently on the mixture formation unit 30, for feeding in combustion air 21. Gas 23 is fed to the mixture formation unit 30 via a supply line 22. The gas 23 is advantageously fed in a liquid phase, to which end the supply line 22 ends within the gas tank 11 of the work apparatus 1 by way of an opening 24, into which liquid gas enters. The opening 24 is expediently configured as a suction housing 25. A weight 26, in particular a weight body, is preferably arranged on the opening. The weight 26 is advantageously provided in the suction housing 25. A longitudinal section 27 of the supply line 22, which longitudinal section 27 is provided within the gas tank 11, is configured as a flexible hose 28. As a result of the flexible hose 28, the opening 24 of the hose 28 which is weighed down with a weight 26 is dipped under the action of the weight force into the liquid phase of the stored gas 29 in the gas tank 11. This ensures that exclusively liquid gas of the stored gas 29 which is provided in the gas tank 11 enters into the opening 24 of the hose 28. The flexibility of the hose 28 ensures that the position of the opening 24 of the supply line 22 in the gas tank 11 changes under the action of the weight force and the operational position of the work apparatus 1.

The elastic longitudinal section 27 of the supply line 22 extends as a hose 28 from the opening 24 in the liquid gas phase as far as a pass through 32 in the tank wall 33. An extraction valve 34 is preferably provided in the pass through 32, which extraction valve 34 makes the extraction of the stored, liquid gas 29 from the gas tank 11 possible.

As FIG. 3 shows, the gas tank 11 is fixed on the crank case 40 of the combustion engine 10 in the embodiment which is shown. To this end, the crank case has at least one, preferably two carrying clamps 41, 42 which can be configured, in particular, in one piece with the crank case 40. The cylinder 18 is fixed on the crank case 40, a crank shaft 43 being mounted in the crank case, which crank shaft 43 is connected to the piston 20 via a connecting rod 44.

The combustion engine 10 is a reed valve-controlled combustion engine 10, in particular a two stroke engine. That inlet 45 of the combustion engine 10 which is connected to the mixture formation unit 30 opens into the crank case 40. The mixture which enters into the crank case 40 via the inlet 45 is compressed in the case of a downwardly moving piston 20 and is pushed out into the combustion chamber 19 of the cylinder 18 via transfer channels 46, 47. In the case of an upwardly moving piston 20, the mixture is compressed and, in the region of the top dead center of the reciprocating movement, is ignited by way of an ignition apparatus (not shown in greater detail), as a result of which the piston 20 is driven downward again. The combustion gases are discharged via an exhaust gas outlet 48. The inlet 45, the transfer channels 46 and 47 and the exhaust gas outlet 48 are controlled by way of the piston 20 which moves up and down.

In addition to the extraction valve 34, the gas tank 11 has a fill valve 35 and expediently a pressure relief valve 36 for gaseous gas. As FIGS. 3 and 4 show, furthermore, a protective cage 38 is provided within the gas tank 11, in which protective cage 38 a level gage 49 is arranged. The level gage 49 is expediently configured as a float 39 which includes a hollow body 51 which floats on the liquid surface of the filling level 37. A predefined filling level 37 of the gas tank 11 can be indicated via the level gage 49. It is provided in one advantageous embodiment of the construction that the float 39 controls at least the fill valve 35 via a control lever 52. If the filling level 37 in the gas tank 11 reaches a predefined height, at least the fill valve 35 is closed via the control lever 52. It can be expedient, as an alternative to the fill valve 35, to control the pressure relief valve 36 via the float 39.

The fill valve 35 and the pressure relief valve 36 open into the gas tank within the protective cage 38. The movable float 39 and the control lever 52 are likewise provided in the protective cage 38. This ensures that the hose 28, the position of which in the gas tank 11 can move, does not impair the mechanism of the level gauge 49 and/or its float 39. The elastic, flexible hose 28 lies permanently outside the protective cage 38.

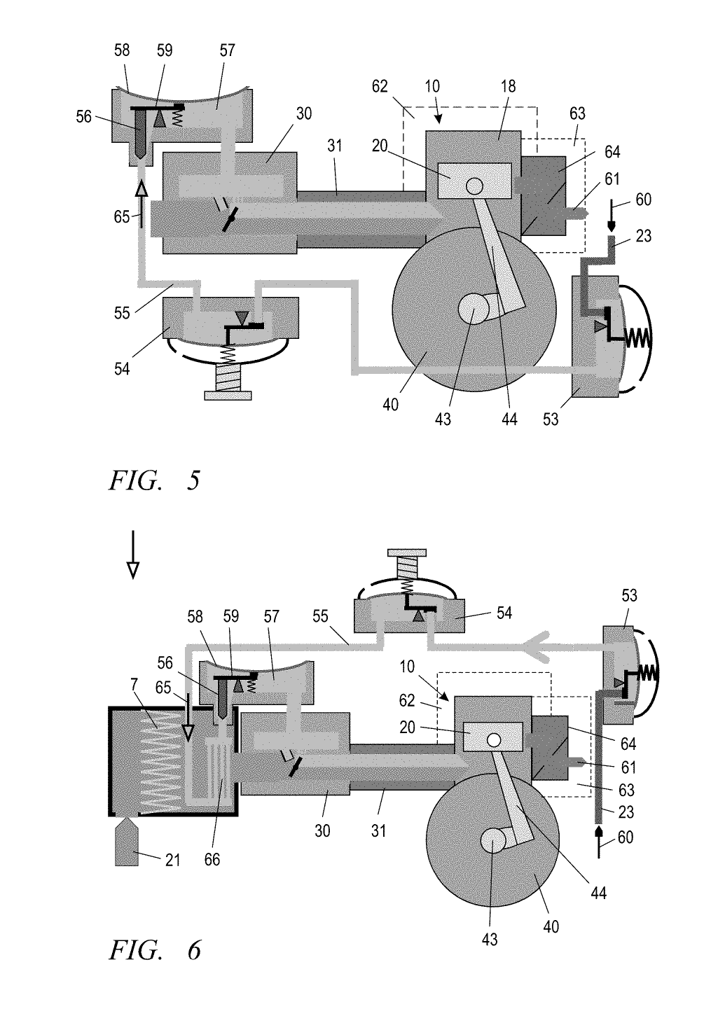

In the following text, the feeding of gas to the mixture formation unit 30 of the combustion engine 10 will be described using the diagrammatic illustrations of FIGS. 5 and 6.

The liquid gas 23 flows in the arrow direction 60 to an evaporator 53. For temperature equalization, the evaporator 53 expediently lies in the spatial region of a heat source, in particular in the spatial region 63 of the discharged exhaust gases 61. The evaporator 53 is heated by the waste heat of the combustion engine 10. In a simple way, the evaporator 53 is arranged in the spatial region 62 of the cylinder and/or in a spatial region 63 of an exhaust muffler 64 of the combustion engine 10. It can also be provided that the exhaust gases 61 are routed in such a way that they flow around the evaporator 53.

The evaporator 53 ensures the transition of the liquid gas 23 which is fed in a liquid phase in the arrow direction 60. A pressure reliever 54 is connected downstream of the evaporator 53. The outlet 55 of the pressure reliever 54 opens via a pressure-controlled control valve 56 into the control chamber 57 of a carburetor, in particular a membrane carburetor. The control chamber 57 is delimited by way of a flexible membrane 58. If gas flows from the control chamber 57 into the mixture formation device 30, the pressure in the control chamber 57 will decrease and the membrane 58 will dip into the control chamber 57. The membrane 58 opens the control valve 56 via a lever assembly 59, with the result that gas in a gaseous phase can flow out of the pressure reliever 54 into the mixture formation unit 30.

The illustration in FIG. 6 corresponds substantially to that in accordance with FIG. 5. In addition, a heat exchanger 66 is provided between the outlet 55 of the pressure reliever 54 and the line connection to the control valve 56, around which heat exchanger 66 the combustion air 21 which is fed in flows. As a result, the gaseous gas 65 is raised in the direction of the temperature of the combustion air 21 which is fed in, before the introduction into the mixture formation unit 30. As FIG. 6 shows, the combustion air 21 which flows in is cleaned by way of an air filter 7 before it flows through the heat exchanger.

It is understood that the foregoing description is that of the preferred embodiments of the invention and that various changes and modifications may be made thereto without departing from the spirit and scope of the invention as defined in the appended claims.

What is claimed is:

1. A handheld work apparatus comprising:
a gas-operated combustion engine having a cylinder with a combustion chamber;
said combustion engine including a piston and an intake channel for feeding in combustion air;
a supply line for a flammable gas;
said combustion chamber being delimited by said piston;
said combustion engine including a mixture formation unit;
a gas tank;
said supply line having an opening defining a position in said gas tank;
said supply line being configured to feed liquid gas to said mixture formation unit, the liquid gas entering into said opening of said supply line within said gas tank, wherein said position of said opening in said gas tank is adjustable;
said supply line including a longitudinal section disposed within said gas tank; and,
said longitudinal section including a flexible hose and a weight arranged in a region of said opening in such a manner that the liquid gas is fed via said opening to said supply line.

2. The work apparatus of claim 1, wherein said opening is configured as a suction housing, and said weight is disposed in said suction housing.

3. The work apparatus of claim 1, wherein:
said gas tank includes a gas tank wall;
said supply line defines a pass-through of said supply line through said gas tank wall; and,
said longitudinal section is an elastic longitudinal section extending from said opening of said supply line as far as said pass-through of said supply line through said gas tank wall.

4. The work apparatus of claim 1, wherein said gas tank is a fillable gas tank which is attached fixedly on the work apparatus as an operating medium tank which is fixed on the work apparatus.

5. The work apparatus of claim 1 further comprising:
a fill valve;
a pressure relief valve for gaseous gas; and,
an extraction valve for liquid gas are arranged on said gas tank.

6. The work apparatus of claim 1 further comprising a level gage configured to indicate a predefined filling level in said gas tank and arranged in said gas tank.

7. The work apparatus of claim 1 further comprising:
a fill valve; and,
a level gage formed as a float configured to indicate a predefined filling level and to close at least said fill valve when said predefined filling level is reached.

8. The arrangement of claim 1 further comprising:
a protective cage;
a level gage arranged within said protective cage; and,
said flexible hose of said supply line being disposed outside of said protective cage.

9. The work apparatus of claim 1 further comprising an evaporator configured to have a liquid gas fed thereto, wherein the liquid gas is heated by waste heat of said combustion engine.

10. The work apparatus of claim 9, wherein:
said combustion engine includes an exhaust muffler; and,
said evaporator is disposed in at least one of a spatial region of said cylinder of said combustion engine and a spatial region of said exhaust muffler.

11. The work apparatus of claim 9 further comprising:
a membrane carburetor having a control chamber;
a pressure reliever having an outlet and being connected downstream of said evaporator; and,
said outlet of said pressure reliever opening into said control chamber of said membrane carburetor.

12. The work apparatus of claim 1, wherein a gaseous gas is raised toward a temperature of the combustion air, which is fed in, before the introduction into said mixture formation unit.

13. The work apparatus of claim 1 further comprising a heat exchanger configured to have a gaseous gas guided therethrough and to have an inflowing combustion air flow therearound.
